(19) United States
(12) Patent Application Publication
(10) Pub. No.: US 2018/0349995 A1
(43) Pub. Date: Dec. 6, 2018

(54) SYSTEM FOR ACCESSING TRANSACTIONAL DATA

(71) Applicants: George Chiramattel Kunjachan, San Jose, CA (US); Amit Arya, Cupertino, CA (US); Peter Allen Vogel, Santa Clara, CA (US)

(72) Inventors: George Chiramattel Kunjachan, San Jose, CA (US); Amit Arya, Cupertino, CA (US); Peter Allen Vogel, Santa Clara, CA (US)

(73) Assignee: Intuit Inc., Mountain View, CA (US)

(21) Appl. No.: 15/610,534

(22) Filed: May 31, 2017

(51) Int. Cl. G06Q 40/04

(52) U.S. Cl. CPC G06Q 40/04

(57) ABSTRACT

A system may include transaction storage devices. Each transaction storage device may include a data store. The system may further include a registry configured to receive, from a user, a first secure identifier. The secure identifier may be generated, using an encoding function, from a user identifier of a user. The registry may be further configured to receive a first selection of a first data store of a first transaction storage device, and store a first registration of the first data store with the first secure identifier. The first registration may include a universal resource identifier (URI) of the first data store. The registry may be further configured to receive, from a service provider, a first request to lookup a data store registered with the first secure identifier, retrieve the first registration, and transmit, to the service provider and using the first registration, the URI of the first data store.

### BACKGROUND

Current standards for exchanging transactional information (e.g., the Open Financial Exchange (OFX), a framework for exchanging financial transactional data and instructions between customers and their financial institutions) do not support the capability to obtain detailed transactional information associated with users. That is, while aggregate-level transactional information may be accessible (e.g., a payment amount of a transaction), transaction details (e.g., line items purchased) are typically unavailable.

In addition, current standards for exchanging financial transactional data typically require point-to-point connections, which grow proportionally with the number of participating organizations, thereby creating bottlenecks. For example, while a point-to-point architecture may be sufficient to support a user's interactions with a few financial institutions, when the architecture is opened to an arbitrary number of service providers, a point-to-point architecture may become unwieldy. Furthermore, substantial overhead may be required to authenticate numerous participants and maintain participant accounts.

Accessing detailed transactional information associated with users is typically based on a “pull” model driven by explicit requests (e.g., to financial institutions). The detailed transactions may be dispersed across multiple service providers, and it may be difficult or impossible to collect such detailed transactions in a timely manner. This hinders access to detailed transaction information, which could be used to support analytics and insights.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, one or more embodiments relate to a system including transaction storage devices. Each transaction storage device includes a data store. The system further includes a registry configured to receive, from a user, a first secure identifier. The secure identifier is generated, using an encoding function, from a user identifier of a user. The registry is further configured to receive, from the user, a first selection of a first data store of a first transaction storage device, and store, in response to receiving the first selection, a first registration of the first data store with the first secure identifier. The first registration includes a universal resource identifier (URI) of the first data store. The registry is further configured to receive, from a service provider, a first request to lookup a data store registered with the first secure identifier, retrieve, in response to the first request, the first registration, and transmit, to the service provider and using the first registration, the URI of the first data store.

In general, in one aspect, one or more embodiments relate to a method including receiving a first secure identifier. The secure identifier is generated, using an encoding function, from a user identifier of a user. The method further includes receiving a first selection of a first data store of a first transaction storage device, and storing, in response to receiving the first selection, a first registration of the first data store with the first secure identifier. The first registration includes a universal resource identifier (URI) of the first data store. The method further includes receiving a first request to lookup a data store registered with the first secure identifier, retrieving, in response to the first request, the first registration, and transmitting, using the registration, the URI of the first data store.

In general, in one aspect, one or more embodiments of the invention relate to a non-transitory computer readable medium including instructions that, when executed by a computer processor, perform a method including receiving a first secure identifier. The secure identifier is generated, using an encoding function, from a user identifier of a user. The method further includes receiving a first selection of a first data store of a first transaction storage device, and storing, in response to receiving the first selection, a first registration of the first data store with the first secure identifier. The first registration includes a universal resource identifier (URI) of the first data store. The method further includes receiving a first request to lookup a data store registered with the first secure identifier, retrieving, in response to the first request, the first registration, and transmitting, using the registration, the URI of the first data store.

Other aspects of the invention will be apparent from the following description and the appended claims.

### BRIEF DESCRIPTION OF DRAWINGS

FIG. 1 shows a system in accordance with one or more embodiments of the invention.

FIG. 2A, FIG. 2B, and FIG. 2C show systems in accordance with one or more embodiments of the invention.

FIG. 3, FIG. 4A, and FIG. 4B show flowcharts of a process in accordance with one or more embodiments of the invention.

FIG. 5A, FIG. 5B, FIG. 5C, and FIG. 5D show examples in accordance with one or more embodiments of the invention.

FIG. 6A and FIG. 6B show a computing system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the invention are directed to a system, method and non-transitory computer readable medium for accessing detailed transaction information generated by transaction sources. In one or more embodiments, the system architecture is based on a registry that maps a secure identifier (e.g., a hash of a user identifier that has been converted to a standardized format) to a link (e.g., a URI) to a data store. Using secure identifiers may protect the privacy of users, so that potentially sensitive user identifiers are not exposed in the registry. The data store includes detailed transactions associated with secure identifiers. Once a user has registered a secure identifier with a data store, various entities may access the registry to lookup a link to the data store corresponding to the secure identifier, and then use that link to push detailed transactions relative to the data store for later access by a financial (e.g., accounting) application selected by a user. The data store may be viewed as similar to an email inbox: anyone may push a transaction to the data store if they know the address of the data store (e.g., just as anyone can send an email message to a recipient if they know the recipient's email address).

Examples of user identifiers may include financial instruments (e.g., credit card numbers), email addresses, usernames, customer loyalty numbers, telephone numbers, etc. A user may own several user identifiers. Examples of transaction sources may include financial institutions (e.g., credit card issuers), retail establishments (e.g., brick and mortar or e-commerce stores), etc. The detailed transaction information may include comprehensive information about line items of the transaction.

Embodiments of the invention relate to creating a standard for facilitating, via a registry, the discovery of where to send detailed transaction information. It may be desirable to employ an open architecture where no single entity owns the registry, in order to encourage various entities to participate on an equal footing. The registry may be collectively operated by members of a consortium (e.g., a consortium analogous to the OFX consortium but whose focus is on mapping secure identifiers to links to data stores). An example of a data store is an accounting system (e.g., QuickBooks Online® or Mint®. Anyone (e.g., a service provider) may access the registry to obtain the location of a data store link (e.g., universal resource identifier, or URI) given a secure identifier. The detailed transaction information may include transactions generated by any service provider (e.g., a brick-and-mortar and/or e-commerce stores). Pre-existing point-to-point connections are not required to access the registry.

Any entity (e.g., a service provider) may transmit new detailed transactions by accessing the registry and finding a link to the data store corresponding to a specific secure identifier. For example, when a user transacts business with a service provider, the service provider may push the corresponding detailed transactions to the user's data store. The service provider may lookup a link to the appropriate data store by presenting, to the registry, a secure identifier generated from a user identifier obtained by the service provider during the transaction (e.g., credit-card number, loyalty number, email address, etc.). For example, when a user transacts business using a user identifier, the corresponding detailed transactions may be pushed to the appropriate data store and stored with the secure identifier corresponding to that user identifier. Therefore transactions corresponding to a secure identifier, although generated from a variety of sources (e.g., service providers) flow to, and may be aggregated at a single data store.

The data store may typically be the user's accounting system. Although the user may not allow general access to read the data in the data store, the user may permit transaction sources (e.g., service providers) to push data to the data store. For example, allowing transaction sources to push data to the data store may assist the user by eliminating the need for the user to perform data entry regarding important transactions.

In one or more embodiments, contextual and user-configurable validation rules determine a validation procedure based on the type of the user identifier corresponding to the secure identifier. For example, email-based validation may be used if the secure identifier was generated from an email address. As another example, a secure identifier generated from a payment card number may be validated by obtaining confirmation from a financial institution that the payment card is valid and actually corresponds to the user. Confirmations from external entities such as financial institutions may be anonymized using tokens that do not include the actual user identifier.

A user may specify (e.g., to the registry) that secure identifiers be linked, either as peers, or where one secure identifier is a master (e.g., the linked secure identifiers may correspond to payment card numbers of a user, and a master secure identifier may correspond to the user's email address).

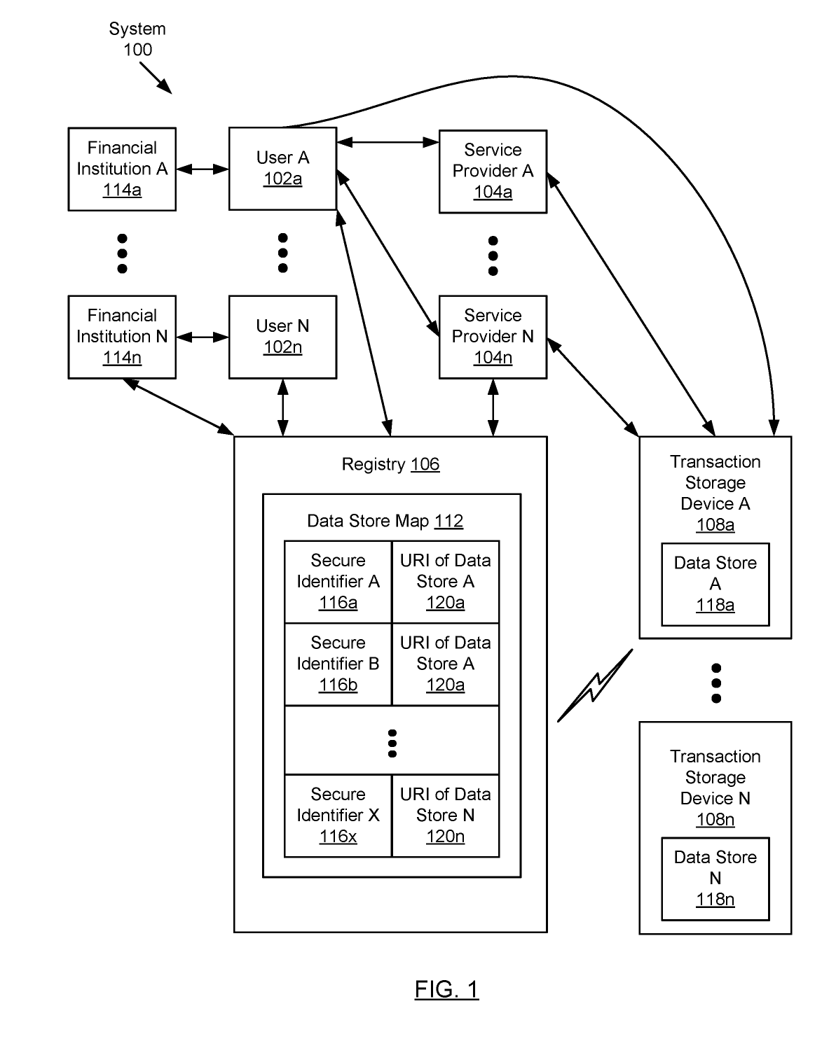

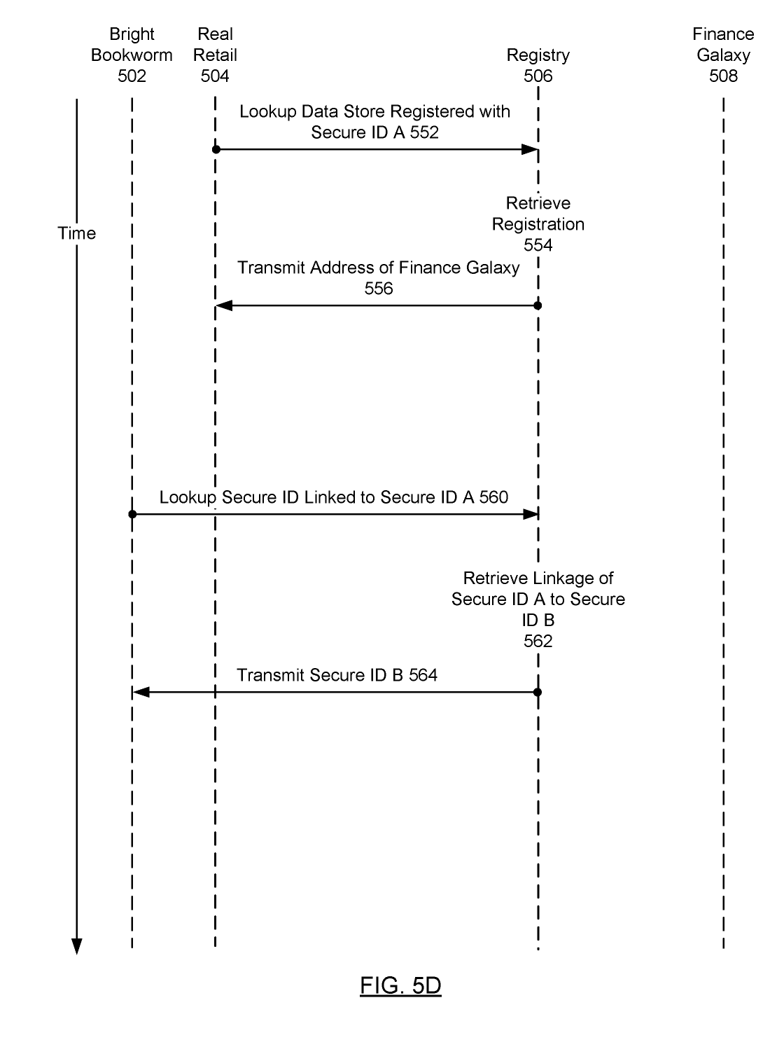

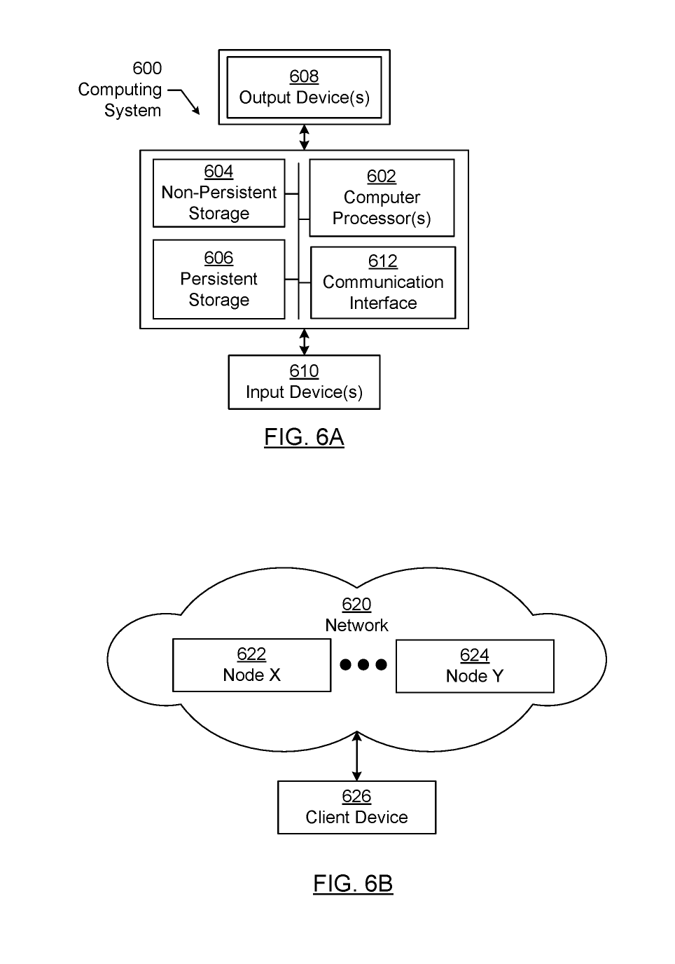

FIG. 1 shows a system (100) in accordance with one or more embodiments of the invention. As shown in FIG. 1, the system (100) includes users (102a-102n), service providers (104a-104n), a registry (106), transaction storage devices (108a-108n), and financial institutions (114a-114n). In one or more embodiments of the invention, the users (102a-102n), service providers (104a-104n), registry (106), and transaction storage devices (108a-108n) may communicate via a computer network (not shown) (e.g., the network (620) described with respect to FIG. 6B).

In one or more embodiments, a user (102a-102n) may be an individual, business, or other entity that receives products and/or services from a service provider (104a-104n). In one or more embodiments, a service provider (104a-104n) is a merchant from which a user (102a-102n) receives products and/or services and for which the user (102a-102n) provides remuneration. In one or more embodiments, a service provider (104a-104n) includes functionality to generate a detailed transaction corresponding to the products and/or services provided to the user (102a-102n). In one or more embodiments, a financial institution (114a-114n) is an organization (e.g., a bank or credit union) that offers credit, loans and/or other financial services to users (102a-102n). One example of a financial institution (114a-114n) is a payment card issuer that offers credit cards and/or debit cards to users (102a-102n).

In one or more embodiments, a transaction includes a group of operations that are either performed completely or not at all (e.g., in order to maintain a consistent state). That is, the transaction may succeed or fail as a unit. For example, a transaction may consist of debit operation that subtracts a value from one account and a credit operation that adds the value to a second account, where either both operations are performed or neither operation is performed. That is, if the transaction is interrupted after performing either the debit or credit operation, then the transaction is undone (i.e., rolled back). In one or more embodiments, a transaction is generated by a service provider (104a-104n). For example, the service provider (104a-104n) may need to record and monitor which line items are involved in the transaction, in order to track the inventory levels corresponding to those line items.

In one or more embodiments of the invention, a transaction storage device (108a-108n) includes any type of storage unit and/or device (e.g., a file system, database, collection of tables, or any other storage mechanism) for storing data. Further, a transaction storage device (108a-108n) may include multiple different storage units and/or devices. The multiple different storage units and/or devices may or may not be of the same type or located at the same physical site. In one or more embodiments, a transaction storage device (108a-108n) may be all or part of a computing system, such as, for example, the computing system (600) discussed below in the description of FIG. 6A, or may be all or part of a client device, such as, for example, the client device (626) discussed below in the description of FIG. 6B.

In one or more embodiments, a transaction storage device (108a-108n) includes a data store (118a-118n). In one or more embodiments, a data store (118a-118n) stores information about transactions. Examples of data stores (118a-118n) include personal financial management applications, such as Mint® (Mint is a trademark of Intuit, Inc., Mountain View, Calif.), and business management applications, such as Intuit® QuickBooks Online® (Intuit and QuickBooks Online are trademarks of Intuit, Inc., Mountain View, Calif.), that store information about transactions of users (102a-102n) and enable users (102a-102n) to manage their financial activities.

In one or more embodiments of the invention, the registry (106) includes any type of storage unit and/or device (e.g., a file system, database, collection of tables, or any other storage mechanism) for storing data. Further, the registry (106) may include multiple different storage units and/or devices. The multiple different storage units and/or devices may or may not be of the same type or located at the same physical site. In one or more embodiments, the registry (106) may be all or part of a computing system, such as, for example, the computing system (600) discussed below in the description of FIG. 6A.

In one or more embodiments, the registry (106) includes a data store map (112). In one or more embodiments, the data store map (112) includes a mapping of secure identifiers (116a-116x) to universal resource identifiers (URIs) of data stores (120a-120n). In other words, a URI of a data store (120a-120n) is registered with a corresponding secure identifier (116a-116x), indicating which data store (118a-118n) is designated to store detailed transactions corresponding to the secure identifier (116a-116x). In one or more embodiments, a URI is a string of characters used to identify a resource. For example, the resource may be the data store 118a-118n) and the URI may include an address (e.g., network location) of the data store (118a-118n). In one or more embodiments, a secure identifier (116a-116x) may correspond to a user identifier. In one or more embodiments, a user identifier may have a type. In one or more embodiments, a secure identifier (116a-116x) may have the same type as the user identifier corresponding to the secure identifier (116a-116x). Examples of types of user identifiers may include financial instruments (e.g., credit card numbers), email addresses, usernames, customer loyalty numbers, telephone numbers, etc.

In one or more embodiments, a data store (118a-118n) may contain information (e.g., information about detailed transactions) corresponding to a secure identifier (116a-116x). A specific data store (118a-118n) may contain information corresponding to multiple secure identifiers (116a-116x). In one or more embodiments, a data store (118a-118n) includes functionality to process a request to push (e.g., store) detailed transactions corresponding to a secure identifier (116a-116x).

In one or more embodiments, a secure identifier (116a-116x) may be generated from the user identifier via an encoding function. In one or more embodiments, the encoding function is a hash function. For example, a secure identifier (116a-116x) may be generated from the user identifier via a one-way hash function that converts a variable-length input into a fixed-length binary sequence, such that it may be infeasible to retrieve the user identifier from the hashed binary sequence. In one or more embodiments, the user identifier is first converted into a standardized format before applying the hash function. For example, if the user identifier is an email address, converting to the standardized format may remove all whitespace and/or special characters from the email address, and/or representing the email address using all lowercase letters. As another example, if the user identifier is a payment card number, converting to the standardized format may append a four-digit expiration date associated with the payment card to the payment card number.

Alternatively, other encoding and/or cryptographic techniques (e.g., encryption techniques) may be used to generate a secure identifier (116a-116x) from a user identifier, in order to provide a layer of security to protect potentially sensitive user identifiers (e.g., credit card numbers).

In one or more embodiments, the registry (106) includes functionality to process a request from a user (102a-102n) to register a URI of a data store (120a-120n) with a secure identifier (116a-116k) generated from a user identifier. In one or more embodiments, the registry (106) includes functionality to process a request (e.g., from a service provider (104a-104n)) to lookup a URI of a data store (120a-120n) registered with a secure identifier (116a-116k).

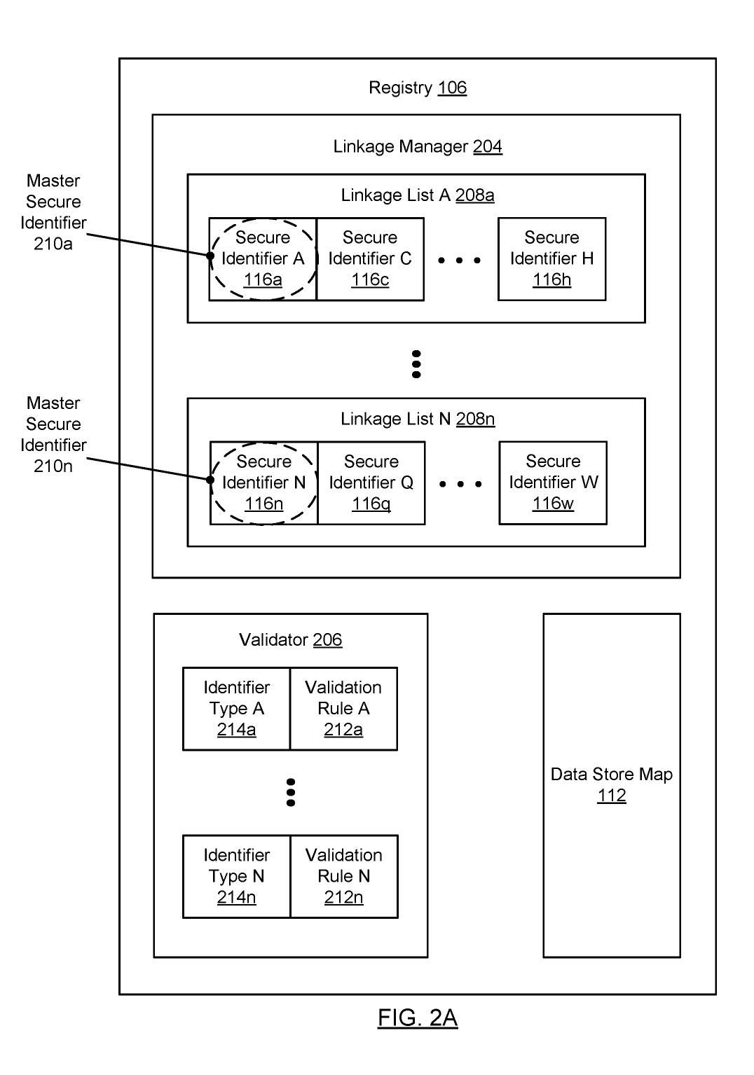

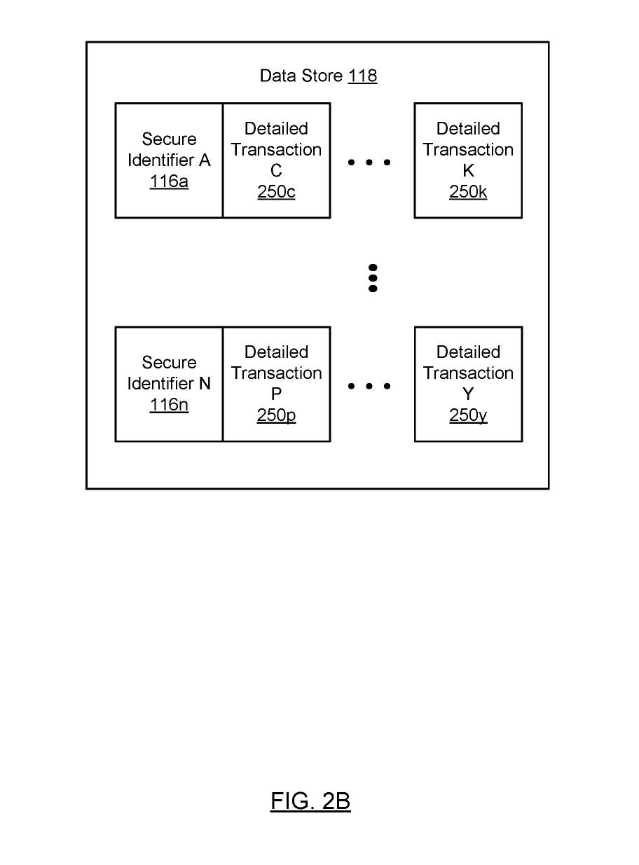

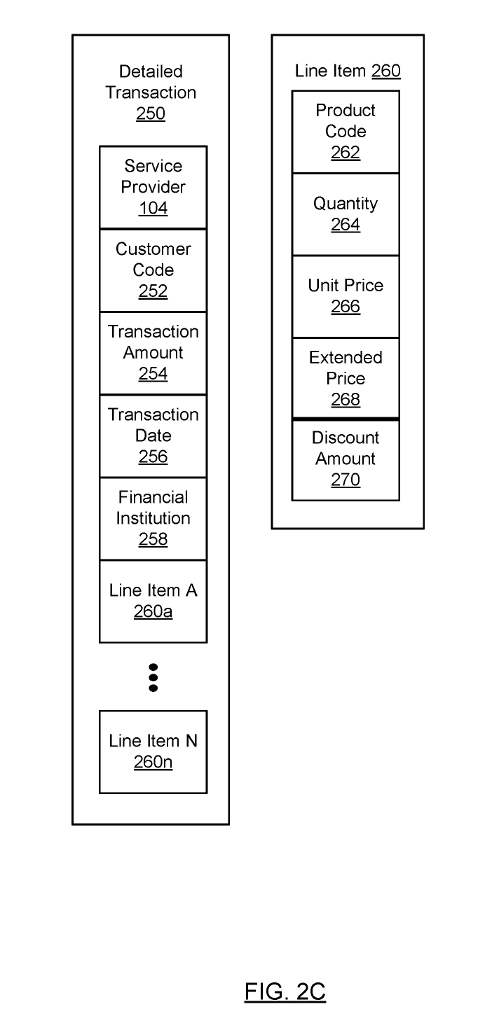

Turning to FIG. 2A, in one or more embodiments, the registry (106) includes, in addition to the aforementioned data store map (112), a linkage manager (204), and a validator (206). In one or more embodiments, the linkage manager (204) may be implemented in hardware (e.g., circuitry), software, or any combination thereof. In one or more embodiments, the linkage manager (204) includes linkage lists (208a-208n). In one or more embodiments, the linkage manager (204) includes functionality to link two secure identifiers (116a-116n).

In one or more embodiments, each linkage list (208a-208n) includes a list of related secure identifiers ((116a-116h), (116n-116w), etc.). In one or more embodiments, the secure identifiers ((116a-116h), (116n-116w), etc.) within a linkage list (208a-208n) may correspond to user identifiers of the same user (102a-102n). For example, the secure identifiers ((116a-116h), (116n-116w), etc.) within a linkage list (208a-208n) may correspond to various credit card numbers, debit card numbers, email addresses, customer loyalty numbers, etc. of a single user (102a-102n). In one or more embodiments, different secure identifiers ((116a-116h), (116n-116w), etc.) in a secure identifier linkage list (208a-208n) may be registered with different data stores (118a-118n).

In one or more embodiments, multiple linkage lists (208a-208n) may be associated with a single user (102a-102n). For example, each linkage list (208a-208n) associated with the user (102a-102n) may correspond to a specific type of user identifier, such as credit card numbers, email addresses, customer loyalty numbers, etc.

In one or more embodiments, a linkage list (208a-208n) may include secure identifiers ((116a-116h), (116n-116w), etc.) corresponding to multiple users (102a-102n). For example, the linkage list (208a-208n) may include secure identifiers ((116a-116h), (116n-116w), etc.) corresponding to users (102a-102n) that are business partners. As another example, the linkage list (208a-208n) may include secure identifiers ((116a-116h), (116n-116w), etc.) corresponding to users (102a-102n) that belong to the same family (e.g., parent and child).

In one or more embodiments, the secure identifiers ((116a-116h), (116n-116w), etc.) of a linkage list (208a-208n) are considered to be “peers” that are linked to each of the other secure identifiers ((116a-116h), (116n-116w), etc.) of the linkage list (208a-208n). For example, a group of secure identifiers ((116a-116h), (116n-116w), etc.) that correspond to frequent flyer numbers may be considered to be peers.

In contrast, in one or more embodiments, a secure identifier (116a-116n) may be assigned as a master secure identifier (210a-210n) for a specific secure identifier linkage list (208a-208n). In one or more embodiments, the master secure identifier (210a-210n) is linked to the remaining non-master, or “slave” secure identifiers ((116c-116h), (116q-116w), etc.) in the linkage list (208a-208n). For example, in FIG. 2A, secure identifier A (116a) is the master secure identifier (210a) of secure identifier linkage list A (208a), where the remaining secure identifiers (116c-116h) in linkage list A (208a) are slave secure identifiers.

In one or more embodiments, the slave secure identifiers ((116c-116h), (116q-116w), etc.) in the secure identifier linkage list (208a-208n) may not considered to be linked to one another. That is, in one or more embodiments, the slave secure identifiers ((116c-116h), (116q-116w), etc.) in the secure identifier linkage list (208a-208n) may only be considered to be linked to the master secure identifier (210a-210n). For example, a group of secure identifiers ((116a-116h), (116n-116w), etc.) that correspond to credit card numbers may include a primary (e.g., master) credit card number and alternate (e.g., slave) credit card numbers.

In one or more embodiments, linkage lists (208a-208n) may be implemented using various data structures (e.g., linked lists, records in tables, etc.).

In one or more embodiments, the validator (206) may be implemented in hardware (e.g., circuitry), software, or any combination thereof. In one or more embodiments, the validator (206) includes functionality to validate a secure identifier (116a-116n) obtained from the user (102a-102n). In one or more embodiments, the validator (206) includes validation rules (212a-212n) corresponding to identifier types (214a-214n).

The identifier type (214a-214n) may be the type of the user identifier corresponding to a secure identifier (116a-116n). In one or more embodiments, a validation rule (212a-212n) may specify that a particular validation procedure be used when the secure identifier (116a-116n) corresponds to a particular identifier type (214a-214n). For example, one validation procedure may be performed when the identifier type (214a-214n) is an email address, and another validation procedure may be performed when the identifier type (214a-214n) is a payment card number.

Continuing this non-limiting example, a secure identifier (116a-116n) corresponding to an email address of the user (102a-102n) may be validated by confirming that an email message sent to the email address is received by the user (102a-102n). Alternatively, a secure identifier (116a-116n) corresponding to a payment card number of the user (102a-102n) may be validated by obtaining validation of the payment card number from a financial institution (114a-114n) associated with the payment card.

Turning to FIG. 2B, in one or more embodiments, a data store (118) includes a set of detailed transactions ((250c-250k), (250p, 250y), etc.) corresponding to each secure identifier (116a-116n). A detailed transaction ((250c-250k), (250p, 250y), etc.) may describe products and/or services received by a user (102a-102n) from a service provider (104a-104n).

Turning to FIG. 2C, in one or more embodiments, a detailed transaction (250) may correspond to and/or augment Level 3 data used in the credit card industry, and may include the following information: service provider (104), customer code (252), transaction amount (254), transaction date (256), financial institution (258), and a set of line items (260a-260n). In one or more embodiments, the customer code (252) may be a customer code that allows a cardholder (e.g., a corporate cardholder) to track purchases made with the user identifier (e.g., credit card) corresponding to the secure identifier (116a-116n). For example, different employees of a company may have access to a company credit card, and may be assigned different customer codes. In one or more embodiments, the customer code (252) may be any identifier associated with a customer (e.g., the user (102a-102n)). In one or more embodiments, a detailed transaction (250) may include more than one customer code (252). In one or more embodiments, a detailed transaction (250) may also include the following information: tax amount, invoice number, order number, etc. In one or more embodiments, a financial institution (258) may be a bank, credit and/or debit card provider, etc. For example, the financial institution (258) may effect a transfer of funds between an account of a user (102a-102n) and an account of a service provider (104a-104n), relative to a detailed transaction (250) describing products and/or services provided by the service provider (104a-104n) to the user (102a-102n).

In one or more embodiments, the information about each line item (260) may include a product code (262), quantity (264), unit price (266), extended price (268), and item discount amount (270). In one or more embodiments, the information about each line item (260) may also include: a commodity code, item description, unit of measure, shipping cost, item total amount, etc.

While FIG. 1, FIG. 2A, FIG. 2B, and FIG. 2C show configurations of components, other configurations may be used without departing from the scope of the invention. For example, various components may be combined to create a single component. As another example, the functionality performed by a single component may be performed by two or more components.

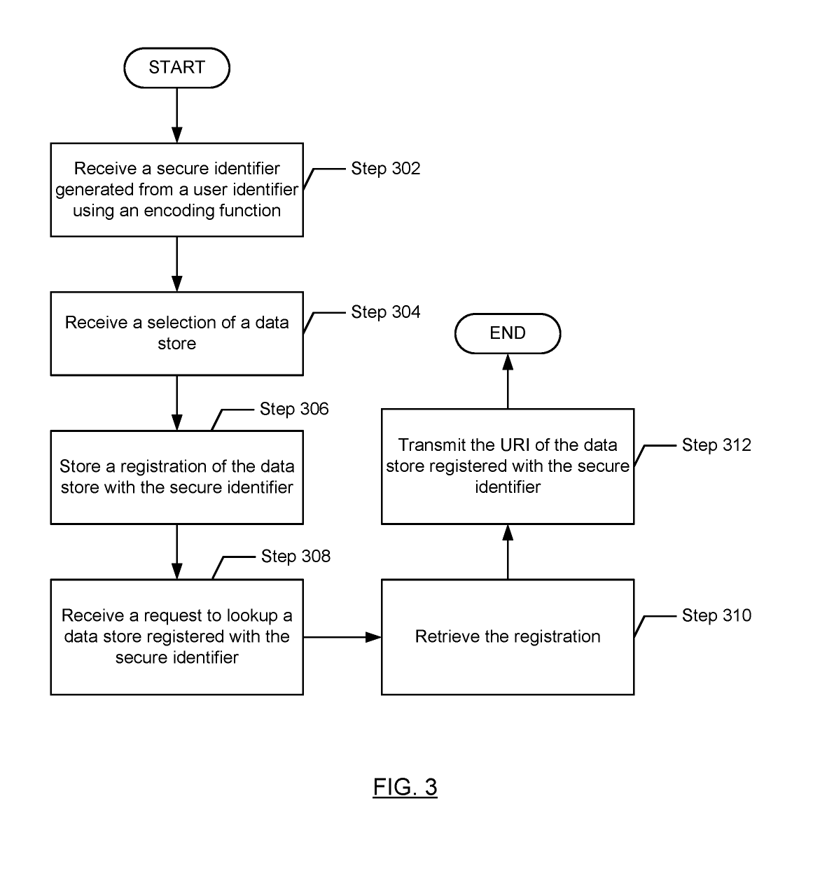

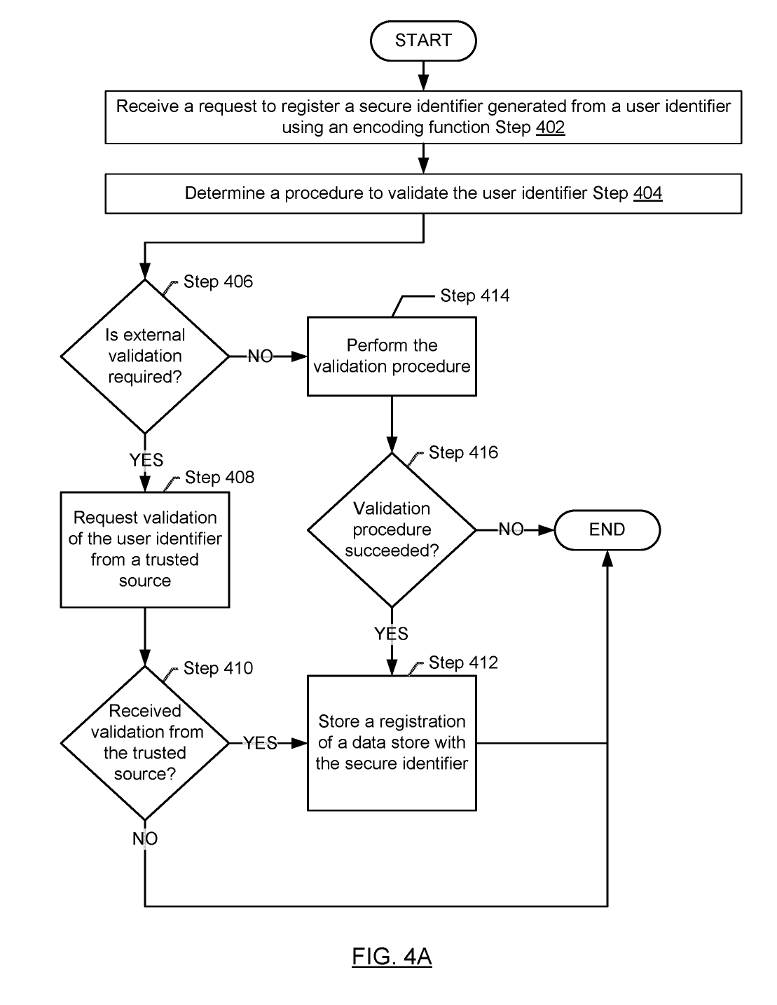

FIG. 3 shows a flowchart in accordance with one or more embodiments of the invention. The flowchart depicts a process for accessing transactional data. In one or more embodiments, the process described in reference to FIG. 3 is practiced using the system (100) (e.g., the registry (106), a transaction storage device (108), and a data store (118),) described in reference to FIG. 1, FIG. 2A, FIG. 2B, and FIG. 2C above, and/or involving the computing system (600) described in reference to FIG. 6A. In one or more embodiments of the invention, one or more of the steps shown in FIG. 3 may be omitted, repeated, and/or performed in a different order than the order shown in FIG. 3. Accordingly, the scope of the invention should not be considered limited to the specific arrangement of steps shown in FIG. 3.

Initially, in Step 302, a secure identifier is received from a user. In one or more embodiments, the user may be an individual, business, or other entity that receives products and/or services from a service provider. In one or more embodiments, the secure identifier is generated, using an encoding function, from a user identifier of the user. Examples of user identifiers may include financial instruments (e.g., credit card numbers), email addresses, usernames, customer loyalty numbers, telephone numbers, etc. For example, the secure identifier may be generated from the user identifier via a one-way hash function that converts a variable-length input into a fixed-length binary sequence, such that it may be infeasible to retrieve the user identifier from the hashed binary sequence.

In one or more embodiments, the secure identifier is received by the registry. In one or more embodiments, the secure identifier may be transmitted via a user interface, email, or an application programming interface (API).

In one or more embodiments, the secure identifier may be verified (e.g., by the registry). In one or more embodiments, if the user identifier is an email address, then a verification email may be sent to the email address, such that the email address is considered to be verified based on the response of the user to the verification email. For example, the user may respond by replying to or clicking on a link in the verification email.

In Step 304, a selection of a data store is received. In one or more embodiments, the selection indicates that the data store is designated to store detailed transactions corresponding to the secure identifier received in Step 302 above. In one or more embodiments, the selection is transmitted by the user. In one or more embodiments, a detailed transaction describes products and/or services received by the user from a service provider. The detailed transaction may include information similar to Level 3 data used in the credit card industry, and may include the following information: service provider, user identifier, customer code, transaction amount, transaction date, financial institution, and line items.

In Step 306, a registration of the data store with the secure identifier is stored. In one or more embodiments, the registration is stored by the registry. In one or more embodiments, the registration is stored in a data store map that includes a mapping of secure identifiers to URIs of data stores. One reason for including the secure identifier (e.g., a hashed version of the user identifier) in the registration, rather than the user identifier, may be to avoid storing sensitive information in the registry, in case the registry is ever compromised. In one or more embodiments, a data store may contain information corresponding to multiple secure identifiers.

In Step 308, a request to lookup a data store registered with the secure identifier is received. In one or more embodiments, the request is received from a service provider (e.g., a service provider offering products and/or services to the user). In one or more embodiments, the request may be received from a user. In one or more embodiments, the request may be transmitted via a user interface, email, or an API.

In Step 310, the registration of a URI of the data store with the secure identifier is retrieved. In one or more embodiments, the retrieval is performed by the registry. In one or more embodiments, the registry retrieves the registration from the data store map, which maps secure identifiers to URIs of data stores.

In Step 312, the URI of the data store registered with the secure identifier is transmitted. In one or more embodiments, the address is transmitted to the entity who transmitted the request of Step 308 above, thereby enabling the entity to lookup detailed transactions (e.g., in Step 452 below of FIG. 4C) corresponding to the secure identifier included in the data store.

FIG. 4A shows a flowchart in accordance with one or more embodiments of the invention. The flowchart depicts a process for accessing transactional data. In one or more embodiments, the process described in reference to FIG. 4A is practiced using the system (100) (e.g., the registry (106), a transaction storage device (108), and a data store (118)) described in reference to FIG. 1, FIG. 2A, FIG. 2B, and FIG. 2C above, and/or involving the computing system (600) described in reference to FIG. 6A. In one or more embodiments of the invention, one or more of the steps shown in FIG. 4A may be omitted, repeated, and/or performed in a different order than the order shown in FIG. 4A. Accordingly, the scope of the invention should not be considered limited to the specific arrangement of steps shown in FIG. 4A.

Initially, in Step 402, a request to register a secure identifier is received. In one or more embodiments, the secure identifier is generated, using an encoding function, from a user identifier of the user. In one or more embodiments, the request is received by the registry. In one or more embodiments, the request may be transmitted by a user. In one or more embodiments, the request may be transmitted by a service provider (e.g., on behalf of a user who has not yet registered a secure identifier with a data store). In one or more embodiments, the request may be transmitted via a user interface, email, or an application programming interface (API).

In Step 404, a procedure to validate the user identifier is determined. In one or more embodiments, the procedure may be determined using a validation rule corresponding to a type of the user identifier. The validation rule may be obtained from the registry (e.g., a validator of the registry). In one or more embodiments, the type of the user identifier may be an email address, a payment card number, a customer loyalty number, a telephone number, a username, etc. In one or more embodiments, the type of the user identifier may be obtained from the user.

If, in Step 406, it is determined that external validation from one or more trusted sources is required, then in Step 408 validation of the user identifier is requested from each trusted source. For example, the validation rule may specify that a user identifier with type “payment card number” be validated after receiving approval from one or more trusted sources associated with the payment card number. In one or more embodiments, the identity of a trusted source is obtained from the user. In one or more embodiments, the trusted source may be a financial institution that processes transactions (e.g., Visa, MasterCard, American Express, Discover). In one or more embodiments, the trusted source may be a financial institution that issued the payment card (e.g., a bank or credit union). In one or more embodiments, the user contacts the trusted source directly to request validation of the user identifier (e.g., the registry may place the user in direct contact with the trusted source).

In Step 410, it is determined whether validation of the user identifier is received from the trusted source. In one or more embodiments, the trusted source sends a validation token to the user. For example, the validation token may be presented to the registry as evidence that the user identifier (e.g., payment card number) has been validated by the trusted source. In one or more embodiments, the approval token is anonymized (e.g., so that the user identifier is never revealed to the registry).

If Step 410 determines that validation has been received from the trusted source, then in Step 412, a registration is stored that includes the data store of the registration request and the secure identifier. In one or more embodiments, the registration may be stored in a database of the data store (e.g., where the registration record is indexed by the secure identifier).

In one or more embodiments, the request may remove the registration of the data store with the secure identifier. For example, the user may have reconsidered the initial selection of the data store to be registered with the secure identifier.

If, in Step 406 above, it is determined that external validation from a trusted source is not required, then in Step 414 the validation procedure determined in Step 404 above is performed (e.g., by the registry). For example, the validation rule may specify that a user identifier with type “email address” be validated by sending a code to the email address, and prompting the user to enter the code. Alternatively, the validation rule may specify that a user identifier with type “email address” be validated by sending a link to the email address, and prompting the user to click on the link. Still alternatively, the validation rule may specify that a user identifier with type “email address” be validated by obtaining an explicit validation of the email address by the provider of the corresponding email service (e.g., Gmail).

If, in Step 416, it is determined that the validation procedure performed in Step 414 above succeeded, then Step 412 above is performed.

FIG. 4B shows a flowchart in accordance with one or more embodiments of the invention. The flowchart depicts a process for accessing transactional data. In one or more embodiments, the process described in reference to FIG. 4B is practiced using the system (100) (e.g., the registry (106), a transaction storage device (108), a data store (118)) described in reference to FIG. 1, FIG. 2A, FIG. 2B, and FIG. 2C above, and/or involving the computing system (600) described in reference to FIG. 6A. In one or more embodiments of the invention, one or more of the steps shown in FIG. 4B may be omitted, repeated, and/or performed in a different order than the order shown in FIG. 4B. Accordingly, the scope of the invention should not be considered limited to the specific arrangement of steps shown in FIG. 4B.

Initially, in Step 422, a request is received. In one or more embodiments, the request is received by the registry.

If, in Step 424, it is determined that the request of Step 422 is a request to assign master status to a first secure identifier of a user, then in Step 426, an assignment of master status to the first secure identifier is stored (e.g., in a linkage list of the registry). For example, the first secure identifier (i.e., now the master secure identifier) may correspond to an email address of the user, such that the secure identifiers corresponding to other user identifiers (e.g., payment card numbers) of the user are linked to the first secure identifier. In one or more embodiments, the request to assign master status may be transmitted by the user. One reason for assigning master status to the first secure identifier (e.g., a hashed version of the user identifier) in the registration, rather than to the first user identifier, may be to avoid storing sensitive information in the registry, in case the registry is ever compromised.

In one or more embodiments, a subsequent request may remove the assignment of master status to the first secure identifier.

Otherwise, if Step 424 determines that the request is not a request to assign master status, then in Step 428 it is determined whether the request of Step 422 is a request to link the first secure identifier to a second secure identifier. In one or more embodiments, the linkage request may be transmitted by the user.

If Step 428 determines that the request is a request to link the first secure identifier to the second secure identifier, then in Step 430, a linkage between the first secure identifier and the second secure identifier is stored. In one or more embodiments, the linkage may be stored in the registry (e.g., in a linkage list of the registry). In one or more embodiments, the linkage may be stored in a database of the registry, where the linkage record may be indexed by the first secure identifier and/or the second secure identifier.

In one or more embodiments, a subsequent request may remove the linkage of the first secure identifier to the second secure identifier.

Otherwise, if Step 428 determines that the request is not a linkage request, then in Step 432 it is determined whether the request of Step 422 is a request to lookup (e.g., retrieve) a secure identifier linked to the first secure identifier. If Step 432 determines that the request is a request to lookup a secure identifier linked to the first secure identifier, then in Step 434, the linkage corresponding to the first secure identifier is retrieved. Next, in Step 436, the second secure identifier is extracted from the linkage and is transmitted. In one or more embodiments, the request in Step 422 may have been transmitted by the user corresponding to the first secure identifier (e.g., generated from an email address of the user), in order to retrieve the set of linked secure identifiers linked to the first secure identifier. In one or more embodiments, identifying a secure identifier linked to the first secure identifier may help the user obtain a more comprehensive view of the detailed transactions relating to the first secure identifier (e.g., the user may then retrieve detailed transactions corresponding to the linked secure identifier from the data store registered with the linked secure identifier).

In one or more embodiments, the first secure identifier may be linked to multiple secure identifiers. In this scenario, Step 434 may retrieve all linkages from the first secure identifier to other secure identifiers, and Step 436 may extract and transmit each of the other secure identifiers.

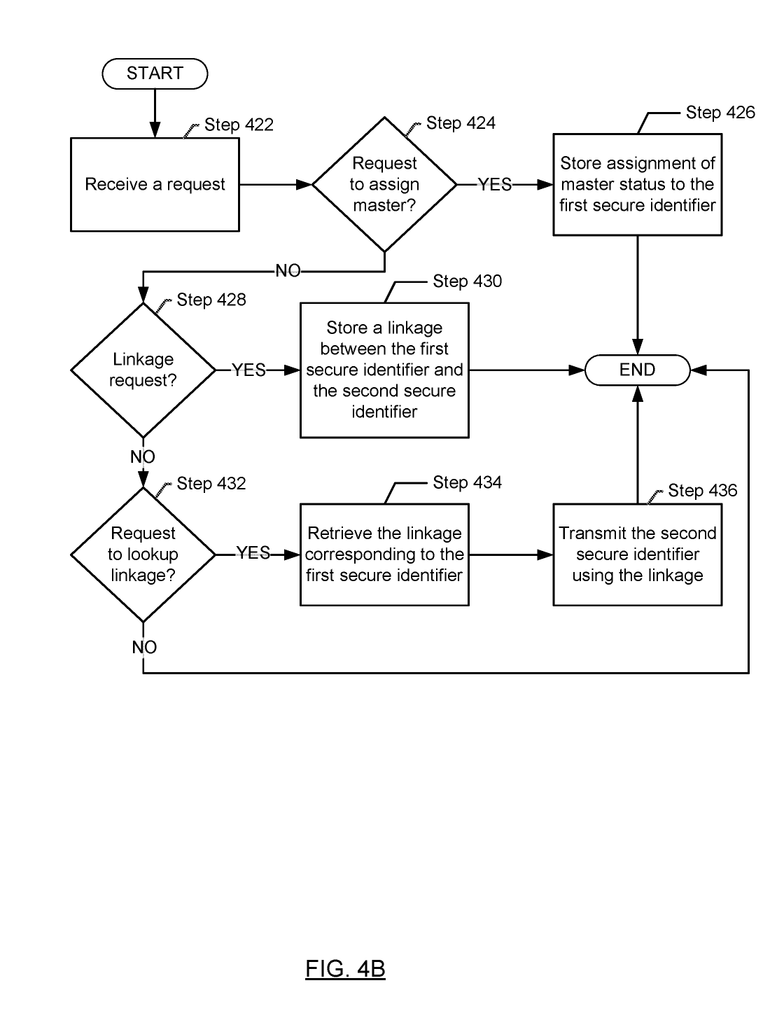

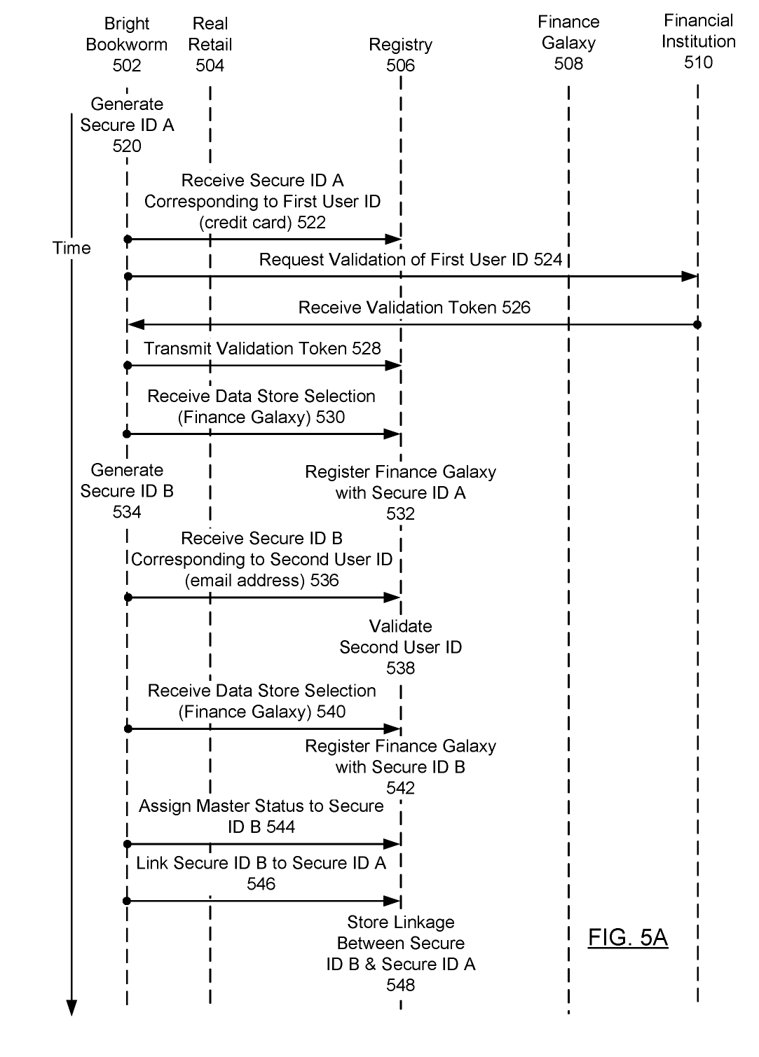

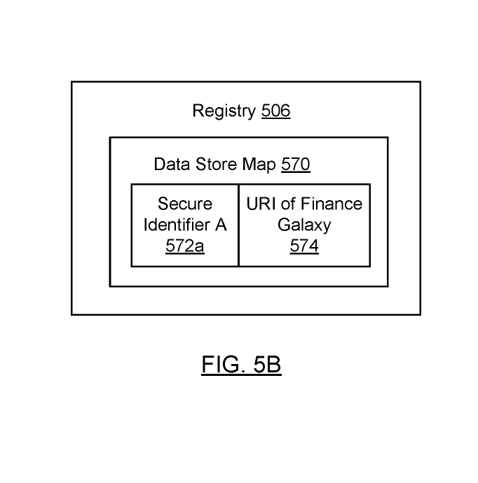

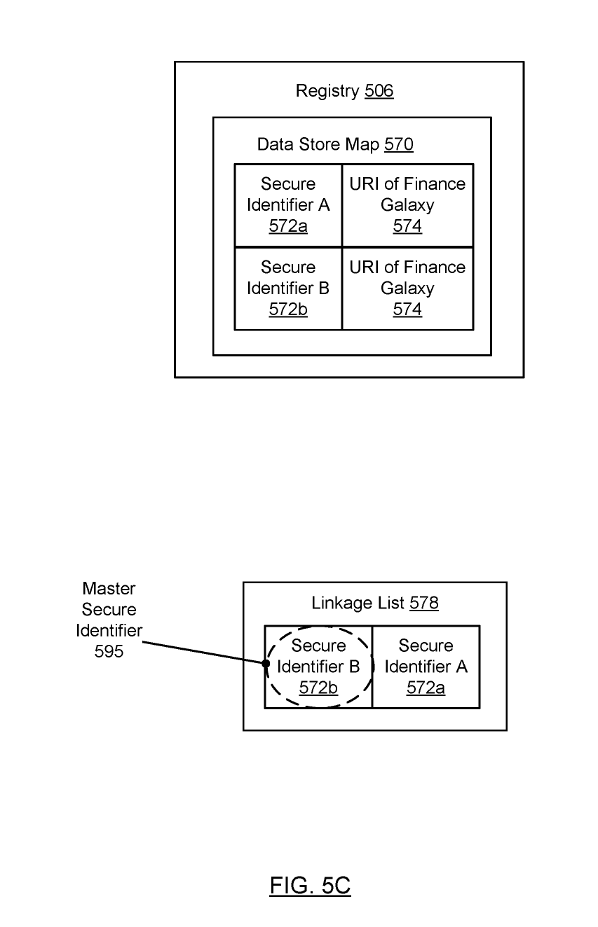

FIG. 5A illustrates, in accordance with one or more embodiments, the relative timing of steps performed by one or more components described in reference to FIG. 1, FIG. 2A, FIG. 2B, and FIG. 2C, in accordance with the flowcharts in FIG. 3, FIG. 4A, and FIG. 4B. These components include: Bright Bookworm, a small bookseller that is a user (502) ((102a-102n) in FIG. 1), Real Retail, a service provider (504) ((104a-104n) in FIG. 1), a registry (506) ((106) in FIG. 1), Finance Galaxy (508), a financial application with data store capabilities, and a financial institution (510) ((114a-114n) in FIG. 1).

Initially, in Step 520, Bright Bookworm (502) generates secure identifier A corresponding to a first user identifier, in this case, a credit card number, using a hash function. Bright Bookworm (502) generates secure identifier A to prepare for registering the credit card number with the Finance Galaxy (508) data store, since the data store map of the registry (506) stores the (anonymized) secure identifier rather than the credit card number.

In Step 522, the registry (506) receives secure identifier A from Bright Bookworm (502). After determining, based on input from Bright Bookworm (502), that the type of secure identifier A is a credit card number, the registry (506) determines, based on a validation rule for secure identifiers of type “credit card number”, that validation from a trusted source associated with the credit card number is required. The registry (506) then instructs Bright Bookworm (502) to obtain validation of the credit card number from Financial Institution (510) (e.g., the issuer of the credit card).

In Step 524, Bright Bookworm (502) requests validation of the credit card number from Financial Institution (510).

In Step 526, Bright Bookworm (502) receives, from Financial Institution (510), a token that includes the validation of the credit card number. The token is anonymized so that the actual credit card number is not revealed to the registry (506) in Step 528. Then, in Step 528, Bright Bookworm (502) transmits the token to the registry (506) as proof that secure identifier A corresponds to a valid user identifier.

In Step 530, the registry (506) receives a selection, from Bright Bookworm (502), of the Finance Galaxy (508) data store to be registered with secure identifier A. That is, Bright Bookworm (502) has indicated that Finance Galaxy (508) should be registered to store detailed transactions corresponding to secure identifier A. Bright Bookworm (502) selects Finance Galaxy (508) from a list of possible data stores because Bright Bookworm (502) has previously stored financial transaction information with Finance Galaxy (508), who has recently joined the consortium (e.g., the system (100)).

In Step 532, the registry (506) stores a registration of Finance Galaxy (508) with secure identifier A. FIG. 5B shows that the data store map (570) of the registry (506) includes a registration of a URI of Finance Galaxy (574) with secure identifier A (572a).

In Step 534, Bright Bookworm (502) generates secure identifier B corresponding to a second user identifier, an email address, using a hash function. Bright Bookworm (502) generates secure identifier B to prepare for registering the email address with the Finance Galaxy (508) data store.

In Step 536, the registry (506) receives secure identifier B from Bright Bookworm (502). After determining, based on input from Bright Bookworm (502), that the type of secure identifier B is an email address, the registry (506) determines a validation procedure, based on a validation rule for email addresses. Then, in Step 538, the registry (506) validates the email address by sending a link to the email address, and waiting for Bright Bookworm (502) to click on the link. When the registry (506) receives notification that Bright Bookworm (502) clicked on the link, secure identifier B is considered to be validated.

In Step 540, the registry (506) receives a selection, from Bright Bookworm (502), of the Finance Galaxy (508) data store to be registered with secure identifier B. That is, Bright Bookworm (502) has indicated that Finance Galaxy (508) should be registered to store detailed transactions corresponding to secure identifier B.

In Step 542, the registry (506) stores a registration of a URI of Finance Galaxy (574) with secure identifier B. FIG. 5C shows that the data store map (570) of the registry (506) includes a registration of a URI of Finance Galaxy (574) with secure identifier B (572b).

In Step 544, Bright Bookworm (502) assigns master status to secure identifier B, because Bright Bookworm (502) decides that it may be useful to link the secure identifier corresponding to the email address to other secure identifiers of Bright Bookworm (502).

In Step 546, the registry (506) receives a request from Bright Bookworm (502) to link secure identifier B to secure identifier A.

In Step 548, the registry (506) stores a linkage between secure identifier B (572b) and secure identifier A (572a) in a linkage list (578), as shown in FIG. 5C. The secure identifier linkage list (578) also shows that secure identifier B (572b) is a master secure identifier (595).

FIG. 5D illustrates, in accordance with one or more embodiments, the relative timing of steps performed by one or more components described in reference to FIG. 1, FIG. 2A, FIG. 2B, and FIG. 2C, in accordance with the flowcharts in FIG. 3, FIG. 4A, and FIG. 4B. FIG. 5D continues the scenario that was begun in FIG. 5A.

Initially, in Step 552, the registry (506) receives a request, from online retailer Real Retail (504), to lookup a data store registered with secure identifier A. Real Retail (504) transmits this request in order to obtain the address of the data store that Real Retail (504) may use to push detailed transactions corresponding to secure identifier A.

In Step 554, in response to the lookup request, the registry (506) retrieves, a registration of Finance Galaxy (508) with secure identifier A. FIG. 5B shows the registration of Finance Galaxy (508) with secure identifier A (572a) in the data store map (570) of the registry (506).

In Step 556, the registry (506) then transmits the address of Finance Galaxy (508) to Real Retail (504).

Bright Bookworm (502) decides to query the registry (506) in order to find out which secure identifiers are linked to a specific secure identifier, in this case secure identifier A (572a). In Step 560, the registry (506) receives a request from Bright Bookworm (502), to lookup a secure identifier that is linked to secure identifier A (572a).

In Step 562, in response to the request of Step 560, the registry (506) retrieves, a linkage of secure identifier B (572b) with secure identifier A (572a), as shown in the linkage list (578) of FIG. 5C.

In Step 564, the registry (506) then transmits secure identifier B (572b) to Bright Bookworm (502).

Now that Bright Bookworm (502) has obtained secure identifier B (572b), which is linked to secure identifier A (572a), Bright Bookworm (502) may then transmit to Finance Galaxy (508) a request to lookup detailed transactions corresponding to secure identifier B (572b).

Embodiments disclosed herein may be implemented on a computing system. Any combination of mobile, desktop, server, router, switch, embedded device, or other types of hardware may be used. For example, as shown in FIG. 6A, the computing system (600) may include one or more computer processors (602), non-persistent storage (604) (e.g., volatile memory, such as random access memory (RAM), cache memory), persistent storage (606) (e.g., a hard disk, an optical drive such as a compact disk (CD) drive or digital versatile disk (DVD) drive, a flash memory, etc.), a communication interface (612) (e.g., Bluetooth interface, infrared interface, network interface, optical interface, etc.), and numerous other elements and functionalities.

The computer processor(s) (602) may be an integrated circuit for processing instructions. For example, the computer processor(s) may be one or more cores or micro-cores of a processor. The computing system (600) may also include one or more input devices (610), such as a touchscreen, keyboard, mouse, microphone, touchpad, electronic pen, or any other type of input device.

The communication interface (612) may include an integrated circuit for connecting the computing system (600) to a network (not shown) (e.g., a local area network (LAN), a wide area network (WAN) such as the Internet, mobile network, or any other type of network) and/or to another device, such as another computing device.

Further, the computing system (600) may include one or more output devices (608), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (602), non-persistent storage (604), and persistent storage (606). Many different types of computing systems exist, and the aforementioned input and output device(s) may take other forms.

Software instructions in the form of computer readable program code to perform embodiments disclosed herein may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments disclosed herein.

The computing system (600) in FIG. 6A may be connected to or be a part of a network. For example, as shown in FIG. 6B, the network (620) may include multiple nodes (e.g., node X (622), node Y (624)). Each node may correspond to a computing system, such as the computing system shown in FIG. 6A, or a group of nodes combined may correspond to the computing system shown in FIG. 6A. By way of an example, embodiments disclosed herein may be implemented on a node of a distributed system that is connected to other nodes. By way of another example, embodiments disclosed herein may be implemented on a distributed computing system having multiple nodes, where each portion disclosed herein may be located on a different node within the distributed computing system. Further, one or more elements of the aforementioned computing system (600) may be located at a remote location and connected to the other elements over a network.

Although not shown in FIG. 6B, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X (622), node Y (624)) in the network (620) may be configured to provide services for a client device (626). For example, the nodes may be part of a cloud computing system. The nodes may include functionality to receive requests from the client device (626) and transmit responses to the client device (626). The client device (626) may be a computing system, such as the computing system shown in FIG. 6A. Further, the client device (626) may include and/or perform all or a portion of one or more embodiments disclosed herein.

The computing system or group of computing systems described in FIGS. 6A and 6B may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file.

The computing system in FIG. 6A may implement and/or be connected to a data repository. For example, one type of data repository is a database. A database is a collection of information configured for ease of data retrieval, modification, re-organization, and deletion. Database Management System (DBMS) is a software application that provides an interface for users to define, create, query, update, or administer databases.

The user, or software application, may submit a statement or query into the DBMS. Then the DBMS interprets the statement. The statement may be a select statement to request information, update statement, create statement, delete statement, etc. Moreover, the statement may include parameters that specify data, or data container (database, table, record, column, view, etc.), identifier(s), conditions (comparison operators), functions (e.g. join, full join, count, average, etc.), sort (e.g. ascending, descending), or others. The DBMS may execute the statement. For example, the DBMS may access a memory buffer, a reference or index a file for read, write, deletion, or any combination thereof, for responding to the statement. The DBMS may load the data from persistent or non-persistent storage and perform computations to respond to the query. The DBMS may return the result(s) to the user or software application.

The above description of functions present only a few examples of functions performed by the computing system of FIG. 6A and the nodes and/or client device in FIG. 6B. Other functions may be performed using one or more embodiments disclosed herein.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system, comprising:
a plurality of transaction storage devices, each transaction storage device of the plurality of transaction storage devices comprising a data store; and
a registry configured to:
receive, from a user, a first secure identifier, wherein the first secure identifier is generated, using an encoding function, from a first user identifier of a user;
receive, from the user, a first selection of a first data store of a first transaction storage device of the plurality of transaction storage devices;
store, in response to receiving the first selection, a first registration of the first data store with the first secure identifier, wherein the first registration comprises a universal resource identifier (URI) of the first data store;
receive, from a service provider, a first request to lookup a data store registered with the first secure identifier;
retrieve, in response to the first request, the first registration; and
transmit, to the service provider and using the first registration, the URI of the first data store.

2. The system of claim 1, wherein the registry is further configured to:
obtain a type of the first user identifier; and
determine, using the type, a procedure to validate the first user identifier.

3. The system of claim 2, wherein the procedure comprises requesting validation of the first user identifier from a trusted source.

4. The system of claim 1, wherein the registry comprises a linkage manager configured to:
receive, from the user, a second request to link the first secure identifier to a second secure identifier, wherein the second secure identifier is generated, using the encoding function, from a second user identifier of the user; and
store, in response to the second request, a linkage between the first secure identifier and the second secure identifier.

5. The system of claim 4, wherein the linkage manager is further configured to:
receive, from the user, a third request to assign master status to the first secure identifier; and
store, in response to the third request, an assignment of master status to the first secure identifier,
wherein storing the linkage is based on the assignment of master status to the first secure identifier.

6. The system of claim 4, wherein the linkage manager is further configured to:
receive, from the service provider, a third request to lookup a secure identifier linked to the first secure identifier;
retrieve, in response to the third request, the linkage; and
transmit, to the service provider and using the linkage, the second secure identifier.

7. The system of claim 4, wherein the linkage manager is further configured to:
receive, from the user, a second selection of a second data store of a second transaction storage device of the plurality of transaction storage devices; and
store, in response to receiving the second selection, a second registration of the second data store with the second secure identifier, wherein the second registration comprises a URI of the second data store, wherein the first data store and the second data store are different.

8. The system of claim 1, further comprising:
the service provider configured to:
provide the first request to lookup a data store registered with the first secure identifier; and
receive, from the registry, the URI of the first data store.

9. A method, comprising:
receiving a first secure identifier, wherein the first secure identifier is generated, using an encoding function, from a first user identifier of a user;
receiving a first selection of a first data store of a first transaction storage device;
storing, in response to receiving the first selection, a first registration of the first data store with the first secure identifier, wherein the first registration comprises a universal resource identifier (URI) of the first data store;
receiving a first request to lookup a data store registered with the first secure identifier;
retrieving, in response to the first request, the first registration; and
transmitting, using the registration, the URI of the first data store.

10. The method of claim 9, further comprising:
obtaining a type of the first user identifier; and
determining, using the type, a procedure to validate the first user identifier.

11. The method of claim 10, wherein the procedure comprises requesting validation of the first user identifier from a trusted source.

12. The method of claim 9, further comprising:
receiving a second request to link the first secure identifier to a second secure identifier, wherein the second secure identifier is generated, using the encoding function, from a second user identifier of the user; and
storing, in response to the second request, a linkage between the first secure identifier and the second secure identifier.

13. The method of claim 12, further comprising:
receiving a third request to assign master status to the first secure identifier; and
storing, in response to the third request, an assignment of master status to the first secure identifier,
wherein storing the linkage is based on the assignment of master status to the first secure identifier.

14. The method of claim 12, further comprising:
receiving a third request to lookup a secure identifier linked to the first secure identifier;
retrieving, in response to the third request, the linkage; and
transmitting, using the linkage, the second secure identifier.

15. The method of claim 12, further comprising:
receiving a second selection of a second data store of a second transaction storage device of the plurality of transaction storage devices; and
storing, in response to receiving the second selection, a second registration of the second data store with the second secure identifier, wherein the second registration comprises a URI of the second data store, wherein the first data store and the second data store are different.

16. A non-transitory computer readable medium comprising instructions that, when executed by a computer processor, perform a method comprising:
receiving a first secure identifier, wherein the first secure identifier is generated, using an encoding function, from a first user identifier of a user;
receiving a first selection of a first data store of a first transaction storage device;
storing, in response to receiving the first selection, a first registration of the first data store with the first secure identifier, wherein the first registration comprises a universal resource identifier (URI) of the first data store;
receiving a first request to lookup a data store registered with the first secure identifier;
retrieving, in response to the first request, the first registration; and
transmitting, using the registration, the URI of the first data store.

17. The non-transitory computer readable medium of claim 16, wherein the method further comprises:
obtaining a type of the first user identifier; and
determining, using the type, a procedure to validate the first user identifier.

18. The non-transitory computer readable medium of claim 17, wherein the procedure comprises requesting validation of the first user identifier from a trusted source.

19. The non-transitory computer readable medium of claim 16, wherein the method further comprises:
receiving a second request to link the first secure identifier to a second secure identifier, wherein the second secure identifier is generated, using the encoding function, from a second user identifier of the user; and
storing, in response to the second request, a linkage between the first secure identifier and the second secure identifier.

20. The non-transitory computer readable medium of claim 19, wherein the method further comprises:
receiving a third request to assign master status to the first secure identifier; and
storing, in response to the third request, an assignment of master status to the first secure identifier,
wherein storing the linkage is based on the assignment of master status to the first secure identifier.

21. The non-transitory computer readable medium of claim 19, wherein the method further comprises:
receiving a third request to lookup a secure identifier linked to the first secure identifier;
retrieving, in response to the third request, the first linkage; and
transmitting, using the linkage, the second secure identifier.
